(19) United States
(12) Patent Application Publication
(10) Pub. No.: US 2003/0016343 A1
(43) Pub. Date: Jan. 23, 2003

(54) Synchronous laser tracking system

(75) Inventors: Benny Allan Greene, Isaacs (AU); Hiroo Kunimori, Koganei (JP)

Correspondence Address: CROWELL & MORING LLP, INTELLECTUAL PROPERTY GROUP, P.O. BOX 14300, WASHINGTON, DC, 20044-4300, US

(73) Assignee: Electro Optic Systems Pty Ltd.

(21) Appl. No.: 10/234,172

(22) Filed: Sep. 5, 2002

Related U.S. Application Data
(63) Continuation of application No. 08/983,469, filed on May 19, 1998, now abandoned.
Application No. 08/983,469 is a 371 of international application No. PCT/AU96/00414, filed on Jul. 1, 1996.

(30) Foreign Application Priority Data
Jun. 30, 1995 (AU) PN 3933/95

(51) Int. Cl. G01C 3/00; G01C 3/08; G01C 5/00

(52) U.S. Cl. 356/3.01

(57) ABSTRACT

A method of obtaining a set of measurements for making a position determination. Laser ranging measurements are made from at least two spaced apart stations with respect to a common distant moving object. The ranging measurements utilise respective signals transmitted from the stations so as to impact the moving object at substantially the same time. By making ranging measurements for a plurality of positions of the moving object the position determination can be made by triangulation techniques.

### FIELD OF THE INVENTION

This invention relates generally to position determination techniques and has particular though not exclusive application to satellite laser ranging systems.

### BACKGROUND ART

Satellite laser ranging systems are used for a variety of applications including tectonic studies and geodynamics. In many of these applications, precise range measurements are made from a network of ground-based laser tracking stations to a satellite in orbit around the earth. Data from many stations is required over a considerable period to determine the satellite orbit with a high degree of precision. Specially designed satellites are required to reduce the error in orbit determination to an acceptably low level.

After the satellite orbit has been determined in this fashion, the individual ground stations' positions relative to the orbit can be determined. Consequently, the distances between ground stations can be calculated, allowing distance measurement on the intercontinental scale to be made with an uncertainty or error of ±1 cm.

This known approach has several disadvantages:

data from the entire globe is required to obtain an accurate orbit, a prerequisite for distance measurement;

specially designed and launched satellites are required;

there are long delays in obtaining a baseline measurement due to the logistics of aggregating data from all over the world;

the temporal density of baseline measurements is limited;

any error in the satellite orbit determination flows into the baseline determination, and there are uncontrollable errors at the 1 cm level, limiting baseline accuracy to 1 cm;

the observational geometry must be optimised for orbit determination rather than baseline accuracy, the prime object of the exercise.

These problems have been recognised for at least 20 years.

Around 20 years ago, in an attempt to achieve terrestrial measurements which were limited by measurement instrument error rather than by the uncertainty in the satellite position (which is of only transitional interest), a technique was devised which includes solving for only short arcs of the satellite orbit, during which the satellite is in the simultaneous view of several ground stations. The orbit is semi-constrained by the fixed geometry of the ground station locations, and baselines can be determined with a reduced level of contamination of orbit error. This technique is called the short arc technique.

It has been found in practice that using these essentially interpolative techniques, the errors in the estimation of the satellite position (orbit) contaminate the quasi-geometric simultaneous solution for the satellite position and ground positions at a high level than expected. The terrestrial measurements are more accurate than from previous techniques, but short arc techniques have not succeeded in providing terrestrial measurements to an accuracy below 1 cm.

### DISCLOSURE OF THE INVENTION

It is therefore an object of the invention to provide an improved approach to optical ranging which can be adapted to satellite laser ranging systems to obtain an accuracy between than ±1 cm, preferably while eliminating or at least alleviating one or more of the aforementioned disadvantages.

The invention entails the principle, when applied to the laser ranging situation, that if all of the ground stations coordinate their laser firing such that the laser beams impact the satellite at substantially precisely the same time, the satellite can be assumed to be stationary for that individual measurement of baselines, and a fixed geometry solution applied. A form of static triangulation can be applied to what was previously a complex dynamic problem.

The invention accordingly provides a method of obtaining a set of measurements for making a position determination comprising effecting an optical ranging measurement for each of at least two spaced apart stations with respect to a common distant object moving on a path of travel which is at least approximately known, characterised in that the optical ranging measurements utilise respective signals transmitted from the stations so as to impact the object at substantially the same time.

Preferably, optical ranging measurements arc effected for a plurality of positions of the moving object so as to facilitate position determination by triangulation techniques.

In an application to position determination on or adjacent the earth's surface, the optical ranging measurement is preferably a laser ranging measurement and the distant moving object is an orbiting satellite. Preferably, in this application, the orbit of the satellite is known so that the uncertainty in the a priori knowledge of the satellite position is no greater than five meters, preferably no greater than 1.5 meters. The particular benefit of the invention arises because an uncertainty of 1.5 meters in the satellite position is realistically achievable, and allows the satellite to be considered stationary in that its movement along its orbit will be less than 0.3 mm.

In the satellite ranging application, any mis-timing of the arrival times of the laser pulses at the satellite must be small enough such that the satellite travels a negligible distance (eg: less than 1 mm) in that time. In practice, this requires that the laser beams hit the spacecraft with a few nanoseconds of each other. Thus, by “substantially the same time” in this context in relation to the impact of the transmitted signals is meant that the signals impact the satellite at a separation in time, if any, no greater than 50 ns, more preferably no greater than 10 ns. In a typical satellite ranging situation, this temporal variation corresponds to the aforementioned 1.5 meter uncertainty in the satellite position. In general, the accuracy of the time synchronisation will depend on the application and on the accuracy required.

Usually, the requirement for synchronisation of the impacts of the transmitted signals at the object requires in turn that the signal sources, eg: lasers, at the stations be fired at different times, as the distance from each station to the object would generally be different.

In a practical embodiment, the method may involve an initial set of optic ranging measurements from the spaced stations wherein the transmission time from the stations is determined from a presumed satellite position, determination of any time intervals between the impacts of the transmitted signals at the object having a predetermined value above which the measurements are considered to entail one or more mutual synchronisation errors, and effecting a further set of optic ranging measurements from the stations utilising one or more modified transmission times in dependence upon the determined synchronisation error(s).

In the general case of a satellite in orbit in space, it will have its coordinates in space-at any time given by [x,y,z], where x, y, and z are coordinates in a three dimensional reference system. These coordinates are sufficient to fully describe the satellite position.

If in turn there are n ground stations tracking the satellite, and if their observations are to be used to determine the satellite position, then there will be 3 n unknowns added to the problem to be resolved. The n stations will provide m observations of the satellite, which will produce a solution for both the satellite and the ground stations coordinates, provided that the number of observations [nm] exceeds the number of unknowns (3×(m+n)]. This assumes that the ground stations do not move with respect to time.

This produces the simple requirement that for each position of the satellite to be resolved, along with the coordinates of the ground stations, at least 4 stations must operate simultaneously to track the satellite.

Provided this simple requirement is met, the tracking system will determine the coordinates of both the stations and the satellite in real time, to an accuracy limited only by the accuracy of the individual stations. For modern laser tracking systems this can be as accurate as 0.5 mm.

The method can be further extended to the precise tracking of missiles, aircraft, and ballistic objects in any environment. The sole requirement being that the number of observations must exceed the number of unknowns for a solution to be reached.

Also, the technique can resolve positions for situations where the tracking “stations” are also moving, provided the sole requirement stated above is met.

It will be appreciated that a satellite laser ranging system utilising the invention may be properly termed a synchronous laser tracking system because it synchronises the arrival time of the target of the independent laser pulses.

### BRIEF DESCRIPTION OF THE DRAWINGS

The invention will now be further described, by way of example only, with reference to the accompanying drawings which is a schematic diagram illustrating the method according to this invention in its application to a satellite ranging.

### EMBODIMENTS OF THE INVENTION

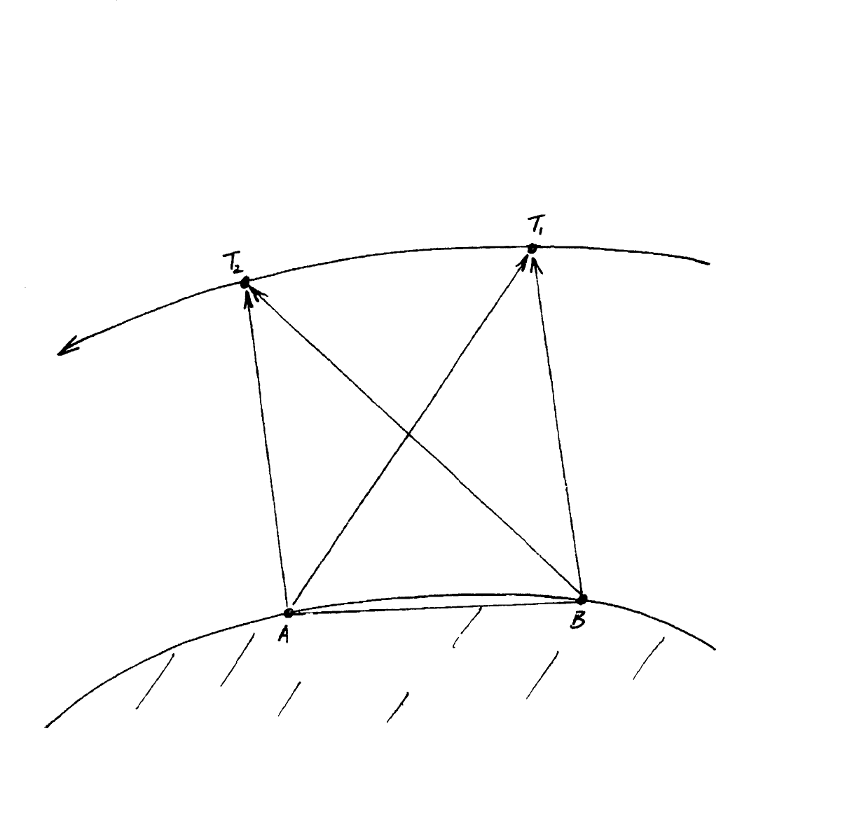

In FIG. 1 the invention is illustrated schematically for a very simple two-dimensional case satellite ranging. Of course, in general, a three-dimension situation will apply and more than two earth stations will be required to effect triangulation with the required accuracy. For example, five or six spaced earth stations, which may well be within the one country or in two or more countries or separate land masses, and/or on sea-going vessels or airborne craft, may be employed to effect the synchronous optical ranging measurements in accordance with the invention.

In the schematically illustrated situation, each of the two earth stations A and B would fire laser signals to the satellite at two separate synchronised sets of times so as to impact the satellite substantially simultaneously at successive times T1 and T2. The distance AB can then be determined by triangulation without reference to the satellite orbit.

In the illustrated situation, a typical maximum satellite velocity is 3×10⁴ m/sec. At this speed, the satellite moves 0.3 mm in 10 ns and it can be shown from the applicable range equations that the uncertainty in the range measurement is 3 cm in 200 psec. With a movement of 0.3 mm between impacts of the transmitted laser signals from the earth stations, one can view the satellite as being substantially stationary, or, put another way, the satellite may be considered stationary (less than 0.3 mm movement) provided the two transmitted signals hit the satellite with 10 ns of each other. However, the 10 ns translates via the range uncertainty into 1.5 meters uncertainty in the a priori knowledge of the satellite position, It can thus be concluded that predications of satellite position with an uncertainty of 1.5 meters represent measurement uncertainties of 1 mm order.

The described arrangement has been advanced merely by way of explanation and many modifications may be made thereto without departing from the spirit and scope of the invention which includes every novel feature and combination of novel features herein disclosed.

Throughout this specification, unless the context requires otherwise, the word “comprise”, or variations such as “comprises” or “comprising”, will be understood to imply the inclusion of a stated integer or group of integers but not the exclusion of any other integer or group of integers.

1. A method of obtaining a set of measurements for making a position determination comprising effecting an optical ranging measurement for each of at least two spaced apart stations with respect to a common distant object moving on a path of travel which is at least approximately known, characterised in that the optical ranging measurements utilise respective signals transmitted from the stations so as to impact the object at substantially the same time.

2. A method as claimed in claim 1, wherein optical ranging measurements are effected for a plurality of positions of the moving object to provide a set of measurements for said position determination by triangulation techniques.

3. A method as claimed in claim 1 or claim 2, wherein said optical ranging measurement is a laser ranging measurement. 4.

4. A method as claimed in any one of claims 1 to 3, wherein said distant moving object is an orbiting satellite.

5. A method as claimed in claim 4, wherein the path of travel of the satellite is known to an uncertainty of no more than 5 meters.

6. A method as claimed in claim 4, wherein the path of travel of the satellite is known to an uncertainty of no more than 1.5 meters.

7. A method as claimed in claim 4, wherein said respective signals impact the satellite with a separation time of no greater than 50 ns.

8. A method as claimed in claim 4, wherein said respective signals impact the satellite with a separation time of no greater than 10 ns.

9. A method as claimed in any one of claims 1 to 8, further comprising the steps of making an initial set of optical ranging measurements from the spaced apart stations using a calculated transmission time from the stations to said moving object, determining any time intervals between the impacts of the respective transmitted signals at the object having a predetermined value above a value considered to entail one or more synchronisation errors and effecting a further set of optic ranging measurements from said stations using one or more modified transmission times determined from said synchronisation error(s).
